(19) United States
(12) Patent Application Publication
(10) Pub. No.: US 2020/0401349 A1
(43) Pub. Date: Dec. 24, 2020

(54) MANAGEMENT DEVICE, INFORMATION PROCESSING SYSTEM, AND NON-TRANSITORY COMPUTER-READABLE STORAGE MEDIUM FOR STORING MANAGEMENT PROGRAM

(71) Applicant: FUJITSU LIMITED, Kawasaki-shi (JP)

(72) Inventor: OSAMU SHIRAKI, Kawasaki (JP)

(73) Assignee: FUJITSU LIMITED, Kawasaki-shi (JP)

(21) Appl. No.: 16/889,863

(22) Filed: Jun. 2, 2020

(30) Foreign Application Priority Data
Jun. 20, 2019 (JP) 2019-114471

(51) Int. Cl. G06F 3/06; G06F 9/50; G06F 9/54

(52) U.S. Cl. CPC G06F 3/0659; G06F 9/5083; G06F 3/0604; G06F 3/0683; G06F 9/542

(57) ABSTRACT

A management device in an information processing system, the information processing system including a plurality of information processing devices and a plurality of storage devices, the management device includes: a memory; and a processor coupled to the memory, the processor being configured to execute a notification information creation processing that includes creating notification information, the notification information indicating, among the plurality of storage devices, one or more first storage devices that may be used by workload operating in a first information processing device among the plurality of information processing devices, and execute a notification processing that includes transmitting the notification information to the first information processing device, the notification information being configured to cause the first information processing device to perform logical connection to each of the one or more first storage devices indicated by the notification information.

### CROSS-REFERENCE TO RELATED APPLICATION

This application is based upon and claims the benefit of priority of the prior Japanese Patent Application No. 2019-114471, filed on Jun. 20, 2019, the entire contents of which are incorporated herein by reference.

### FIELD

The present invention is related to a management device, an information processing system, and a non-transitory computer-readable storage medium for storing a management program.

### BACKGROUND

A storage system has been proposed which is configured in a manner that a storage device and multiple servers included in a casing different from this storage device are connected to one another via a communication path such as a storage area network (SAN).

A technology has been also proposed with which, in the aforementioned storage system, workload is transferred between the servers, and also connection between the storage device and the server is switched along with this workload transfer.

For example, in the SAN-connected storage system, a function has been proposed with which a connection destination is changed in units of management such as host affinity or virtual volumes (WOL) as a technology of VMware (registered trademark). In the host affinity, an accessible logical unit (LU) is set in associated with host information (for example, an IP address). IP is an abbreviation of Internet Protocol. In the VVOL, the LU to be connected is set in units of virtual machine (VM).

These connection controls are performed by a central processing unit (CPU) built in the storage device.

Examples of the related art include Japanese National Publication of International Patent Application No. 2017-512350 and Japanese Laid-open Patent Publication No. 2005-326935.

### SUMMARY

According to an aspect of the embodiments, a management device in an information processing system, the information processing system including a plurality of information processing devices and a plurality of storage devices, the management device includes: a memory; and a processor coupled to the memory, the processor being configured to execute a notification information creation processing that includes creating notification information, the notification information indicating, among the plurality of storage devices, one or more first storage devices that may be used by workload operating in a first information processing device among the plurality of information processing devices, and execute a notification processing that includes transmitting the notification information to the first information processing device, the notification information being configured to cause the first information processing device to perform logical connection to each of the one or more first storage devices indicated by the notification information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating a configuration of a storage system as one example of an embodiment.

FIG. 2 is a diagram exemplifying a functional configuration of a management device in the storage system as one example of the embodiment.

FIG. 3 is a diagram exemplifying workload information in the storage system as one example of the embodiment.

FIG. 4 is a diagram exemplifying volume information in the storage system as one example of the embodiment.

FIG. is a diagram exemplifying a functional configuration of a host device in the storage system as one example of the embodiment.

FIG. 6 is a diagram exemplifying connection information in the storage system as one example of the embodiment.

FIG. 7 is a diagram for describing processing of the management device in the storage system as one example of the embodiment.

FIG. 8 is a diagram for describing processing of the host device in the storage system as one example of the embodiment.

FIG. 9 is a flowchart for describing processing of a first controller of the management device in the storage system as one example of the embodiment,

FIG. 10 is a flowchart for describing processing at the time of reception of volume information of the host device in the storage system as one example of the embodiment.

FIG. 11 is a flowchart for describing processing at the time of activation of workload of the host device in the storage system as one example of the embodiment.

FIG. 12 is a flowchart for describing workload deletion processing of the host device in the storage system as one example of the embodiment.

FIG. 13 is a flowchart for describing volume connection and disconnection processing of the host device in the storage system as one example of the embodiment.

FIG. 14 is a diagram for describing processing when an anomaly occurs at the time of the operation in the storage system as one example of the embodiment.

FIG. 15 is a diagram for describing processing when the anomaly occurs at the time of the operation in the storage system as one example of the embodiment.

FIG. 16 is a diagram for describing processing when the anomaly occurs at the time of the operation in the storage system as one example of the embodiment.

FIG. 17 is a diagram for describing processing when the anomaly occurs at the time of the operation in the storage system as one example of the embodiment,

FIG. 18 is a diagram exemplifying a hardware configuration of the management device in the storage system as one example of an embodiment.

FIG. 19 is a diagram exemplifying a hardware configuration of the host device in the storage system as one example of an embodiment.

### DESCRIPTION OF EMBODIMENT(S)

However, since a low-performance CPU is used as the CPU mounted to the storage device in the above-described related-art storage system in many cases, connection switching takes time. In the first place, it is not supposed that the connection switching (change) between the storage device and the server is performed at a high frequency in the related-art storage system.

In the connection switching between the storage device and the server, for each connection unit between the host, VM, and container and a logical unit, first, detach processing is performed, and thereafter, attach processing is performed.

For this reason, when maintenance operations for the host using transfer of a large amount of VMs and containers, or the like, connection processing is to be performed for each of them, and it takes time to perform the processing.

In recent years, in a virtual system, a more lightweight container technology in which high-speed activation may be performed has been used instead of a virtual machine (VM).

The container has a benefit that the activation is 10 to 100 times faster than the VM, but loses an advantage of the container since the connection switching between the storage device and the server takes time. For example, use of an orchestrator such as kubernetes (registered trademark) provides a benefit that software rolling update is performed easily and also at a high speed, but its feature is not fully exploited.

When a high-performance CPU is included in the storage device, this becomes a factor of cost pressures. Since the processing is performed one by one, there is also a limit regarding performance improvement (scalability).

According to one aspect, the present invention aims at increasing the speed of activation at the workload transfer destination.

According to one embodiment, the speed of activation at the workload transfer destination may be increased.

Hereinafter, an embodiment related to a management device, an information processing system, and a management program of this application will be described with reference to the drawings. The following embodiment, however, is an example and is not intended to exclude the application of various modifications and techniques that are not clearly described in the embodiment. Various modifications and changes may be included in the embodiment without departing from the gist of the embodiment. The drawings are not intended to illustrate that only the drawn components are provided, but the embodiment may include other functions and so on.

(A) Configuration

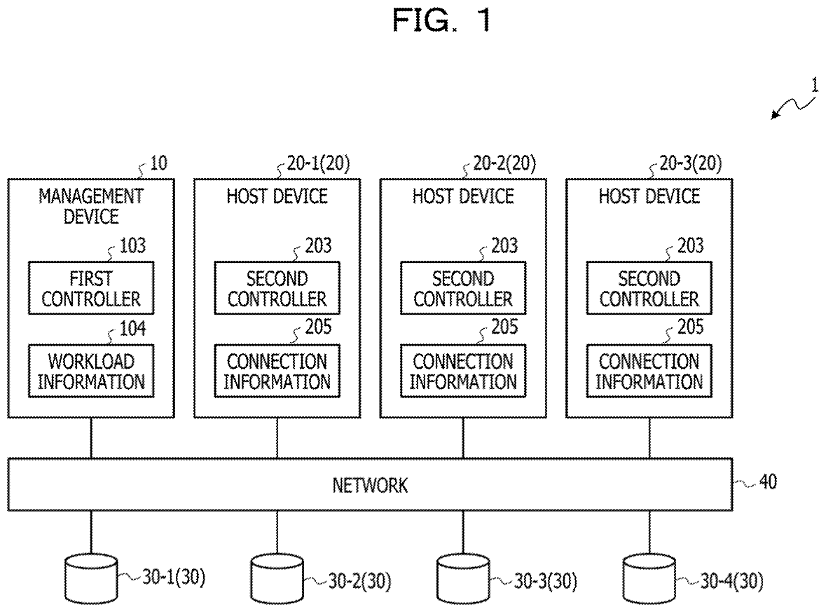

FIG. 1 is a diagram schematically illustrating a configuration of a storage system 1 as one example of the embodiment.

The storage system 1 exemplified in FIG. 1 includes a management device 10, multiple (3 in the example illustrated in FIG. 1) host devices 20-1 to 20-3, and multiple (4 in the example illustrated in FIG. 1) storage devices 30-1 to 30-4.

The management device 10, the host devices 20-1 to 20-3, and the storage devices 30-1 to 30-4 are configured so as to be mutually communicable via a network 40. For example, the network 40 is a local area network (LAN), and functions as a storage area network (SAN).

The storage devices 30-1 to 30-4 are SAN-connected storages. The storage devices 30-1 to 30-4 are storage devices such as a hard disk drive (HDD), a solid state drive (SSD), and a storage class memory (SCM), and store various data.

Hereinafter, as a reference sign denoting the storage device, reference signs “30-1” to “30-4” are used to identify a corresponding one of the multiple storage devices, but reference sign “30” is used to indicate any storage device.

In the storage device 30, multiple storage devices may be used to form Redundant Arrays of Inexpensive Disks (RAIDs).

The storage device 30 functions as a volume used by workload executed in the host devices 20-1 to 20-3 described below. The storage device 30 may be hereinafter referred to as a volume 30 in some cases. The volume 30 may be a logical volume or a physical volume.

The volume 30 is identified by a volume identification (ID). The volume ID may be hereinafter represented as Volume ID in some cases.

The workload may be a container or a virtual machine (VM). According to the present embodiment, an example is illustrated where the workload is a container.

[Functional Configuration of Management Device 10]

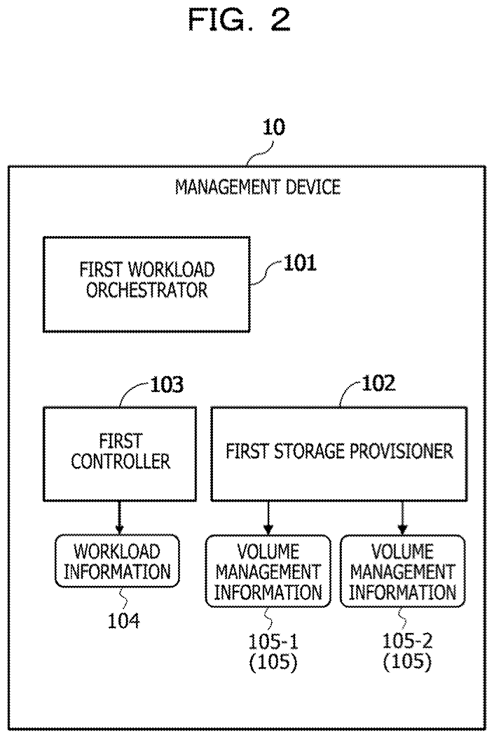

FIG. 2 is a diagram exemplifying a functional configuration of the management device 10 in the storage system 1 as one example of the embodiment.

As illustrated in FIG. 2, the management device 10 includes a first workload orchestrator 101, a first storage provisioner 102, and a first controller 103.

The first workload orchestrator 101 realizes a management function for implementing workload processing.

For example, the first workload orchestrator 101 performs control to allocate workload to the host device 20 to be implemented. The first workload orchestrator 101 also specifies the volume 30 to be used by the workload.

The first workload orchestrator 101 is equivalent to a workload management unit that instructs the host device (first information processing device) 20 to perform the workload processing using the volume 30.

At the time of workload activation, for example, the first workload orchestrator 101 specifies the volume 30 to be used by the workload, and issues, to the host device 20 that executes (processes) the workload, a connection (attach) request to the volume 30.

For example, the first workload orchestrator 101 decides the host device 20 caused to execute the workload. The first workload orchestrator 101 also decides the volume 30 to be used by the workload when the workload is executed.

The first workload orchestrator 101 may also instruct creation of the volume 30 in the storage device 30 (volume creation instruction) via the first storage provisioner 102.

When the volume creation instruction to the first storage provisioner 102 is performed, the first workload orchestrator 101 notifies the first storage provisioner 102 of the volume ID corresponding to identification information for identifying the volume 30 to be created.

The first workload orchestrator 101 also may also use the existing volume 30 for the workload. When the workload is caused to use the existing volume 30, the first workload orchestrator 101 notifies the first storage provisioner 102 of the volume ID corresponding to identification information for identifying the existing volume 30.

The first workload orchestrator 101 also instructs the host device 20 to be connected to the volume 30 (volume connection instruction) via the first storage provisioner 102.

When the volume connection instruction to the first storage provisioner 102 is performed, the first workload orchestrator 101 notifies the first storage provisioner 102 of a host ID corresponding to identification information for identifying the host device 20 to be connected to the volume 30.

The first workload orchestrator 101 causes each of the host devices 20 to activate the workload (workload activation).

When the host device 20 is caused to perform the workload activation, the first workload orchestrator 101 notifies the host device 20 of a workload ID corresponding to identification information for identifying the workload to be activated.

These volume creation instructions, volume connection instruction, and workload activation instruction by the first workload orchestrator 101 may be realized by known techniques, and detailed descriptions of those are omitted.

The present storage system 1 includes a function for proceeding to a maintenance mode for resolving a failure when the failure or the like occurs in any of the host devices 20 in a normal operation state. When the failure or the like is resolved by performing a maintenance operation in this maintenance mode, the present storage system 1 restores from the maintenance mode and returns to the normal operation state.

When the present storage system 1 proceeds to the maintenance mode, the first workload orchestrator 101 performs control for transferring, to another host device 20, the workload allocated to be executed in the host device 20. When the workload is transferred between the host devices 20, the host device 20 corresponding to a transfer source of the workload may be referred to as a transfer source host device 20, and the host device 20 corresponding to a transfer destination of the workload may be referred to as a transfer destination host device 20 in some cases.

When the present storage system 1 restores from the maintenance mode and returns to the normal operation state, the first workload orchestrator 101 performs control for returning the workload which has been transferred from the transfer destination host device 20 to the transfer source host device 20.

The first workload orchestrator 101 may be realized by a manager module of a known workload orchestrator, for example.

The first storage provisioner 102 manages the volume 30 in the present storage system 1. The first storage provisioner 102 manages creation of the volume 30 using the storage device 30, and connection from the host device 20 to the volume 30, for example.

When the volume creation instruction is received from the first workload orchestrator 101, the first storage provisioner 102 instructs creation of the volume 30.

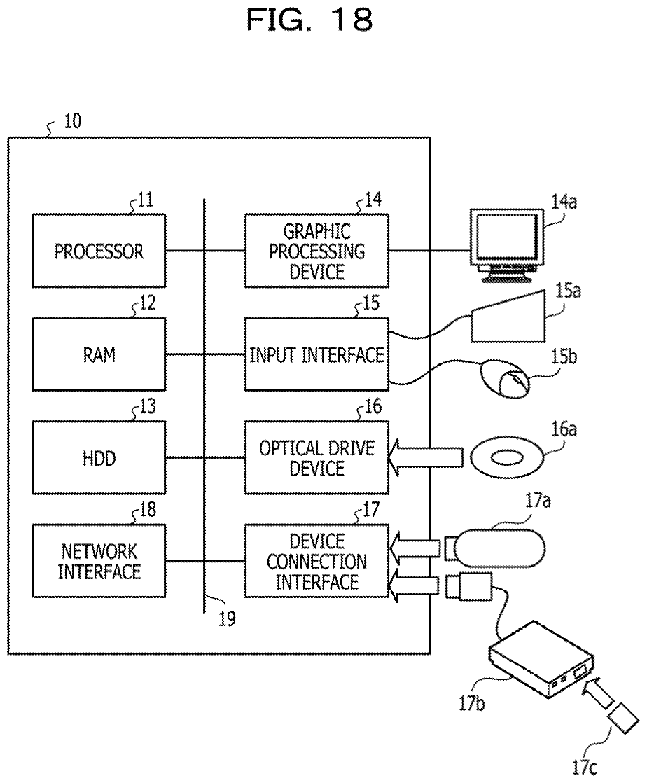

The first storage provisioner 102 stores information regarding the created volume 30 in a random-access memory (RAM) 12 (see FIG. 18) or the like as volume management information 105. The volume management information 105 is generated for each of the volumes 30.

For example, the volume management information 105 may include information of a size of the volume 30, an address of a storage area of the volume 30, and the like with respect to the volume ID.

When the connection instruction to the volume 30 is received from the first workload orchestrator 101, the first storage provisioner 102 notifies the host device 20 (second storage provisioner 202) to be connected to the volume 30 of the connection instruction.

When the host device 20 is notified of the connection instruction to the volume 30, the first storage provisioner 102 may notify the host device 20 of the host ID corresponding to the identification information for identifying the host device 20 of the connection target or the volume ID for identifying the volume 30.

The volume creation and the connection instruction to the host device 20 by the first storage provisioner 102 may be realized by the known techniques, and the detailed descriptions are omitted. The first storage provisioner 102 may be realized by an agent module of a known storage provisioner, for example.

The first controller 103 monitors the volume specification (volume creation) in the present storage system 1, the volume connection, and the workload activation, and creates workload information 104.

The workload information 104 is information regarding the workload, and represents, regarding each workload in the present storage system 1, which one of the host devices 20 executes the workload, and which one of the volumes 30 is used.

The first controller 103 obtains information for creating the workload information 104 based on the processing instruction of the workload using the volume 30 with respect to the host device 20 by the first workload orchestrator 101, and registers these pieces of obtained information in the workload information 104.

Each time the processing instruction of the workload is issued from the first workload orchestrator 101, the first controller 103 performs the above-described information obtainment, and performs additional registration in the workload information 104. Information (for example, the workload ID, the volume ID, or the host ID) regarding the processing instruction of the workload which is performed with respect to each of the host devices 20 from the first workload orchestrator 101 is stored in the workload information 104 as a history (record information).

The workload information 104 is equivalent to the volume 30 used for the workload processing and the history information of the host device 20.

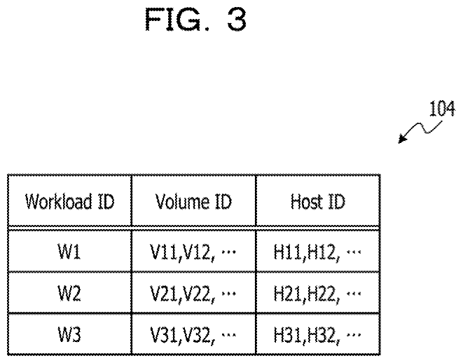

FIG. 3 is a diagram exemplifying the workload information 104 in the storage system 1 as one example of the embodiment.

The workload information 104 exemplified in FIG. 3 is constituted by associating the workload ID with the volume ID and the host ID.

In this example illustrated in FIG. 3, the workload ID is constituted by combining a letter W and numerals such as W1, W2, and W3. The volume ID is constituted by combining a letter V and numerals such as V11, V12, and V21. The host ID is constituted by combining a letter Hand numerals such as H11, H12, and H21.

To create the workload information 104, the first controller 103 obtains the workload ID that each of the host devices 20 (second workload orchestrators 201) is notified of from the first workload orchestrator 101.

To create the workload information 104, the first controller 103 also obtains the volume ID that the first storage provisioner 102 is notified of from the first workload orchestrator 101 together with the volume creation instruction.

To create the workload information 104, the first controller 103 further obtains the host ID notified that the first storage provisioner 102 is notified of together with the volume connection instruction from the first workload orchestrator 101.

This host ID indicates the host device 20 that may execute the workload (hereinafter, referred to as an executable host device 20 in some cases).

For example, the example illustrated in FIG. 3 indicates that there is a possibility that the workload having the workload ID “W1” may be executed by each of the host devices 20 identified by the host IDs such as H11 and H12, and the volumes 30 identified by the volume IDs such as V11 and V12 are used to execute the workload.

The first controller 103 may obtain the executable host device 20 from the host information managed by the first workload orchestrator 101 or from the workload activation record.

All of the host devices 20 that may execute the workload are registered in the host information managed by the first workload orchestrator 101. For this reason, the executable host devices 20 may be promptly obtained by obtaining the executable host device 20 from this host information.

On the other hand, the executable host devices 20 may be efficiently obtained without waste by obtaining the executable host devices 20 from the workload activation record. However, the configuration is not limited to this when a new host device 20 is included.

The first workload orchestrator 101 may transmit these host IDs and workload IDs to the first controller 103, and the first controller 103 may receive and obtain this information.

The first controller 103 functions as an information collection unit that collects information for creating the workload information 104.

The first controller 103 creates the workload information 104 by combining these obtained (collected) volume IDs, host IDs, and workload IDs. The first controller 103 functions as a workload information creation unit that creates the workload information 104.

At the time of the workload activation, the creation request of the volume 30 and the attach request are issued from the first workload orchestrator 101. The first controller 103 creates correspondence relationship between the volume ID notified of from the first workload orchestrator 101 and the workload as the workload information 104.

When the transfer of the workload is performed between the host devices 20 by the first workload orchestrator 101 as described above, the first controller 103 updates the workload information 104.

With respect to the workload ID of the workload transferred between the host devices 20, the host ID of the host after the transfer is set in the host ID in the workload information 104. Accordingly, the correspondence relationship between the host ID and the volume ID changes in the workload information 104.

The first controller 103 creates volume information 106 for notifying the host device 20 of the volume 30 to be connected based on the created workload information 104.

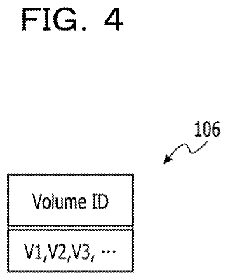

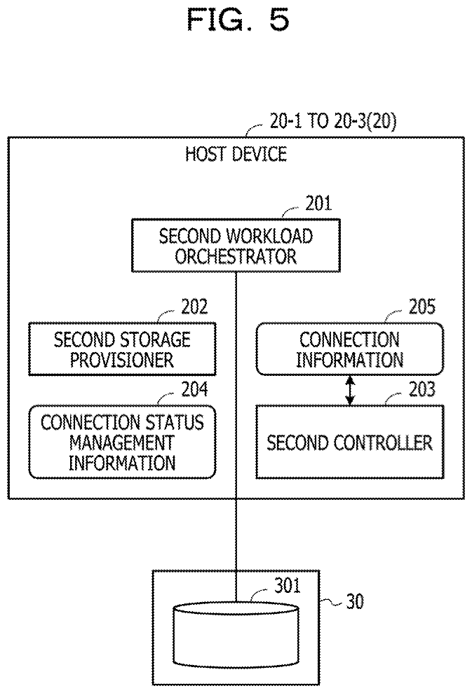

FIG. 4 is a diagram exemplifying the volume information 106 in the storage system 1 as one example of the embodiment.

The volume information 106 exemplified in FIG. 4 includes one or more volume IDs.

The first controller 103 refers to the workload information 104, and extracts the volume ID associated with each of the host devices 20 regarding each of the host devices 20 registered in the host IDs of the workload information 104, to create the volume information 106 for each of the host devices 20.

As described above, the volume IDs of the volumes 30 used for the workload processing in the past and the host IDs of the host devices 20 are recorded in the workload information 104 as the history information.

Therefore, when the volume ID associated with each of the host devices 20 is extracted by referring to the workload information 104, the volume 30 connected at the time of the workload execution in each of the host devices 20 is created as the volume information 106. In this manner, it may be interpreted that there is a possibility that the volume having the connection record in the past in the host device 20 is connected to the host device 20 again. The volume information 106 indicates the volume 30 to which the host device 20 may be connected.

The volume information 106 is equivalent to notification information (volume information 106) indicating, among the multiple volumes 30, one or more volumes 30 that may be used by the workload operating in one host device (first information processing device) 20 among the multiple host devices 20. The first controller 103 is equivalent to a notification information creation unit that creates this notification information (volume information 106).

The first controller 103 transmits (notifies), to each of the host devices 20, the volume information 106 created for each of the host devices 20. The first controller 103 notifies each of the host devices 20 of the volume information 106 to perform notification of the host device of the volume 30 to which each of the host devices 20 is connected.

The management device 10 may manage the volume 30 connected to each of the host devices 20. For example, the management device 10 inquires each of the host devices 20 regarding the currently connected volume 30, and may understand the volume 30 connected to each of the host devices 20.

[Functional Configuration of Host Device 20]

FIG. 5 is a diagram exemplifying a functional configuration of the host devices 20-1 to 20-3 in the storage system 1 as one example of the embodiment.

The host devices 20-1 to 20-3 are computers (information processing devices). The host devices 20-1 to 20-3 have mutually similar configurations.

Hereinafter, as a reference sign denoting the host device, reference signs “20-1” to “20-3” are used to identify a corresponding one of the multiple host devices, but reference sign “20” is used to indicate any host device.

As illustrated in FIG. 5, the host device 20 includes the second workload orchestrator 201, the second storage provisioner 202, and a second controller 203.

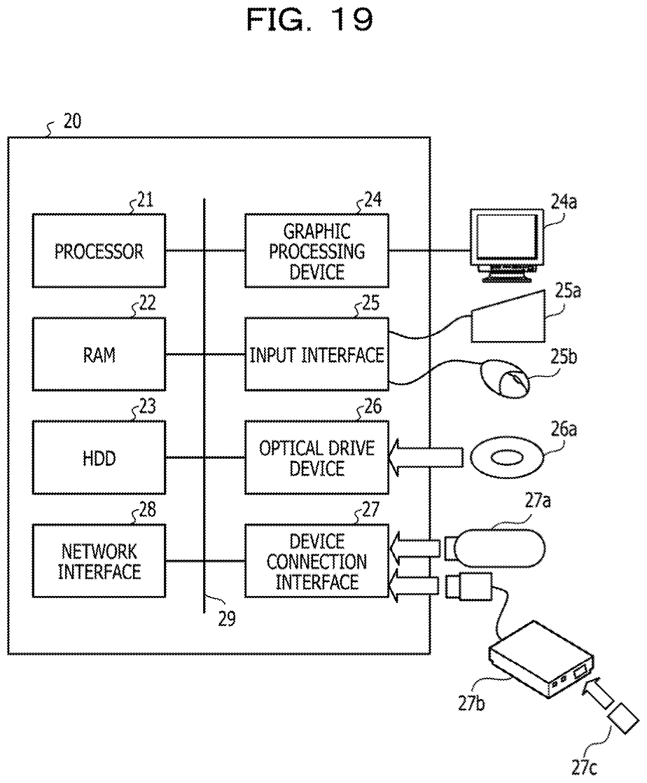

In the host device 20, connection status management information 204 and connection information 205 are stored in a RAM 22 which will be described below (see FIG. 19) or the like. The RAM 22 functions as a storage unit that stores the connection status management information 204 and the connection information 205.

The second workload orchestrator 201 controls the workload execution in the host device 20 (hereinafter, may be referred to as its own host device 20 in some cases) where the second workload orchestrator 201 functions. For example, the second workload orchestrator 201 activates the workload.

The second workload orchestrator 201 may be realized by an agent module of a known workload orchestrator, for example.

The second storage provisioner 202 performs the connection and disconnection of the host device 20 with respect to the volume 30.

Functions as the second workload orchestrator 201 and the second storage provisioner 202 are known, and the detailed descriptions are omitted.

The connection status management information 204 indicates a connection status of the volume 30 in each of the host devices 20 included in the present storage system 1.

In the host device 20, the volume 30 connected to each of the host devices 20 is managed using the connection status management information 204. For example, when each of the host devices 20 mutually notifies the other host devices 20 of the currently connected volume 30 by itself, each of the host devices 20 may understand the volumes 30 connected to the other host devices 20.

The second storage provisioner 202 may be realized by an agent module of a known storage provisioner, for example.

The second controller 203 refers to the connection information 205, and controls the connection and disconnection of the volume 30 with respect to its own host device 20.

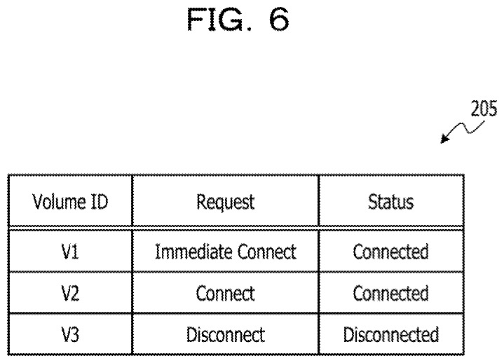

FIG. 6 is a diagram exemplifying the connection information 205 in the storage system 1 as one example of the embodiment.

The connection information 205 exemplified in FIG. 6 is constituted by associating a request (Request) and a connection status (Status) with the volume ID.

The connection status indicates a connection status of the volume 30 with respect to its own host device 20. In the connection information 205 exemplified in FIG. 6, one of values including “Connected” and “Disconnected” is set as the connection status. When the volume 30 is currently connected to its own host device 20, “Connected” is set, and when the volume 30 is not connected to its own host device 20, “Disconnected” is set.

The request indicates how the volume 30 is to be used with respect to its own host device 20, and indicates, for example, a subsequent plan of the volume 30. In the connection information 205 exemplified in FIG. 6, one of values including “Immediate Connect”, “Connect”, and “Disconnect” is set as the request. When the volume 30 is to be connected to its own host device 20, “Connect” is set, and when the volume 30 is to be disconnected from its own host device 20, “Disconnect” is set. When the volume 30 is to be immediately connected to its own host device 20, “Immediate Connect” is set.

The second controller 203 sets these values in the connection information 205 based on the volume information 106 transmitted from the first controller 103 of the management device 10.

The second controller 203 compares the volume ID included in the received volume information 106 with the volume ID set in the connection information 205.

When the volume ID of the volume information 106 is not registered in the connection information 205, the second controller 203 adds this volume ID to the connection information 205, and also sets “Connect” in the request corresponding to the volume ID. Accordingly, the volume 30 is connected to its own host device 20.

When the connection information 205 includes the volume ID that is not included in the volume information 106, the second controller 203 disconnects this volume ID from the connection information 205. Specifically, for example, the second controller 203 sets “Disconnect” in the request corresponding to the volume ID that is not included in the volume information 106 in the connection information 205. Accordingly, the volume 30 is disconnected from its own host device 20.

The second controller 203 refers to the connection information 205 at the time of the workload activation, for example, and sets “Immediate Connect” in the request in the connection information 205 when the volume 30 used by the workload is not yet connected to its own host device 20.

The second controller 203 switches the connection of the volume 30 to its own host device 20 in accordance with the set value in the request in the connection information 205.

The second controller 203 causes the volume 30 where “Immediate Connect” or “Connect” is set in the request in the connection information 205, to be connected to its own host device 20. The second controller 203 causes the volume 30 where “Disconnect” is set in the request in the connection information 205, to be disconnected from its own host device 20.

The second controller 203 causes the connection/disconnection of the volume 30 to its own host device 20 at a timing when a change of the set value in the request in the connection information 205 is detected, for example.

(B) Operation

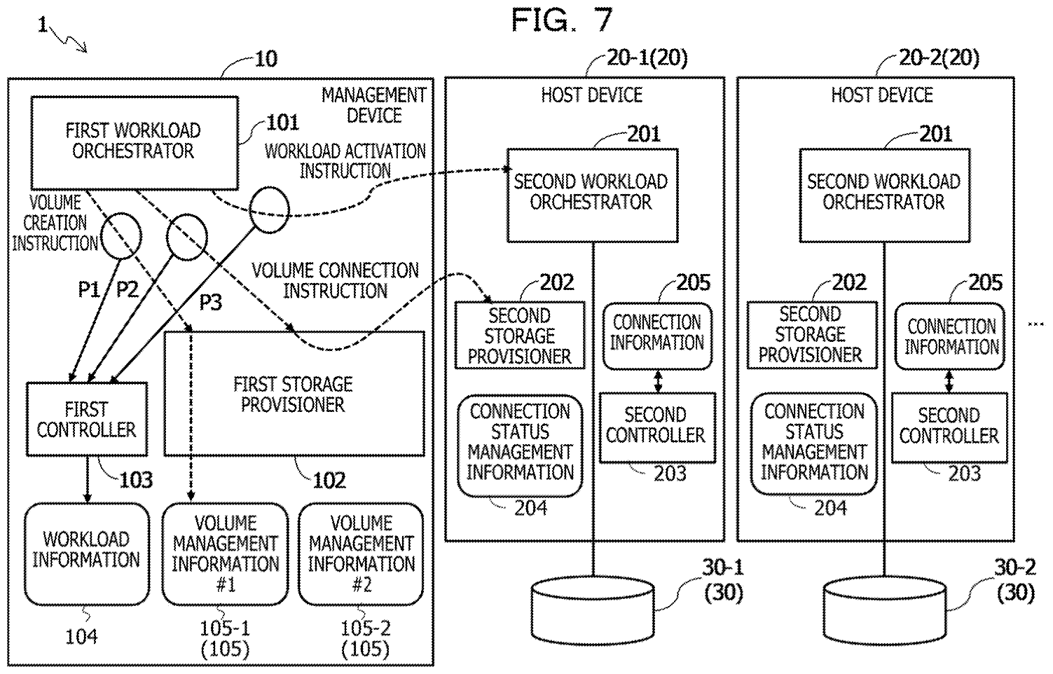

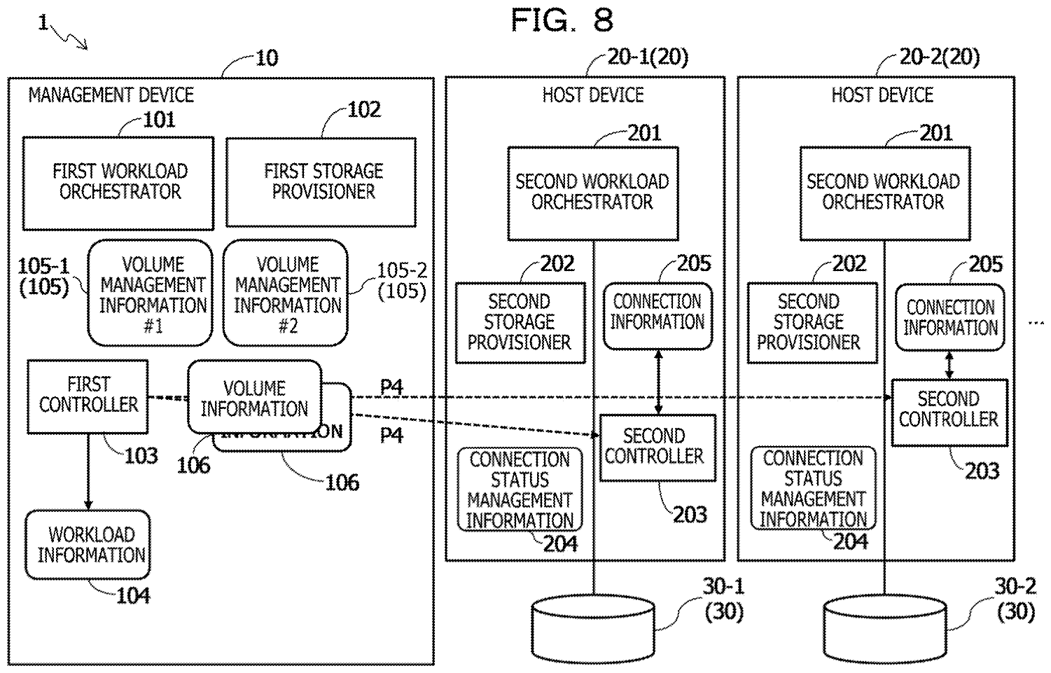

FIG. 7 is a diagram for describing processing of the management device 10 in the storage system 1 as one example of the embodiment, and FIG. 8 is a diagram for describing processing of the host device 20.

In the example illustrated in FIGS. 7 and 8, for convenience, the management device 10, the host devices 20-1 and 20-2, and the storage devices 30-1 and 30-2 are illustrated, and illustrations of configurations other than these are omitted.

In the management device 10, the first controller 103 monitors the volume creation, the volume connection, and the workload activation by the first workload orchestrator 101.

The first controller 103 monitors the volume creation instruction that the first storage provisioner 102 is notified of from the first workload orchestrator 101. When the first workload orchestrator 101 notifies the first storage provisioner 102 of the volume creation instruction, the first controller 103 extracts the volume ID included in this volume creation instruction (see reference sign P1 in FIG. 7).

The first controller 103 monitors the volume connection instruction that the first storage provisioner 102 is notified of from the first workload orchestrator 101. When the first workload orchestrator 101 notifies the first storage provisioner 102 of the volume connection instruction, the first controller 103 extracts the host ID included in this volume connection instruction (see reference sign P2 in FIG. 7).

The first controller 103 monitors the workload activation instruction that the first workload orchestrator 101 notifies the second workload orchestrators 201 of in the host device 20. When the first workload orchestrator 101 notifies the second workload orchestrator 201 of the workload activation instruction, the first controller 103 extracts the workload ID included in this workload activation instruction (see reference sign P3 in FIG. 7).

The first controller 103 creates the workload information 104 by combining these obtained volume IDs, host IDs and workload IDs.

The first controller 103 then creates the volume information 106 for notifying the host device 20 of the volume 30 to be connected based on the created workload information 104.

The first controller 103 transmits (notifies) the volume information 106 created for each of the host devices 20 to the second controller 203 of each of the host devices 20 (see reference sign P4 in FIG. 8).

In the host device 20, the second controller 203 updates the connection information 205 in accordance with the received volume information 106. The second controller 203 performs the connection of the volume 30 when appropriate.

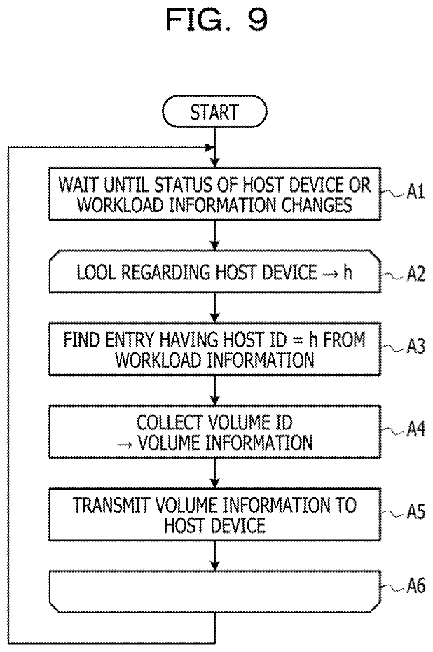

Next, processing of the first controller 103 of the management device 10 in the storage system 1 as one example of the embodiment is described with reference to a flowchart (steps A1 to A6) illustrated in FIG. 9.

In step A1, the first controller 103 waits until the status of the host device 20 changes or the workload information 104 changes. A time when the status of the host device 20 has changed is, for example, a time when the status of the host device 20 turns to an activated state from a stopped state. A time when the workload information 104 has changed is a time when the correspondence relationship between the host ID and the volume ID in the workload information 104 has changed. When the state of the host device 20 has changed or the workload information 104 has changed, the first controller 103 updates the connection information 205 of each of the host devices 20.

In step A2, loop processing for repeatedly implementing control up to step A6 starts with respect to all the host devices 20 included in the host ID of the workload information 104. In the processing described below, the host ID included in the workload information 104 is set as a variable h.

In the following steps A3 to A5, information of the volume 30 connected to the host device 20 of the host ID=h (hereinafter, referred to as a processing target host device 20 in some cases) is collected to create the volume information 106, and the created volume information 106 is transmitted to the processing target host device 20.

In step A3, an entry including the host ID=h is found (extracted) from the workload information 104.

In step A4, the first controller 103 collects the volume ID registered in the entry of the workload information 104 extracted in step A3 to create the volume information 106.

In step A5, the first controller 103 transmits the created volume information 106 to the processing target host device 20.

After that, the contort proceeds to step A6. In step A6, loop end processing corresponding to step A2 is implemented. When the processing regarding all the host devices 20 included in the workload information 104 is completed, the processing returns to step A1.

In the example illustrated in FIG. 9, the first controller 103 performs the processing in steps A3 to A5 with respect to all the host IDs registered in the workload information 104, but the configuration is not limited to this. The processing in steps A3 to A5 may be performed with respect to only the host ID corresponding to a part where the contents have changed in the workload information 104.

For this reason, the management device 10 may store the workload information 104 before the update, and identify the changed part by comparing the workload information 104 before the update with the workload information 104 after the update.

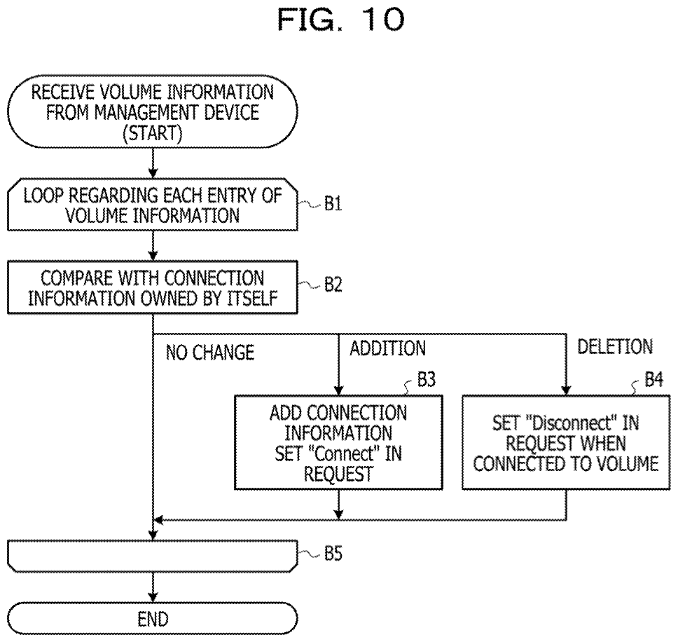

Next, processing at the time of the reception of the volume information 106 of the host device 20 in the storage system 1 as one example of the embodiment is described with reference to a flowchart (steps B1 to B5) illustrated in FIG. 10.

In the host device 20, the second controller 203 updates the connection information 205 when the volume information 106 is received.

In step B1, loop processing for repeatedly implementing control up to step B5 starts with respect to all the entries (volume IDs) existing in the volume information 106.

In step B2, the second controller 203 compares the volume ID selected in step B1 (hereinafter, referred to as a processing target volume ID in some cases) with the connection information 205 stored in its own host device 20.

As a result of the comparison, when the processing target volume ID is not registered in the connection information 205 (see an “addition” route), the process proceeds to step B3. In step B3, the second controller 203 registers the processing target volume ID in the connection information 205, and also sets “Connect” in the request corresponding to the processing target volume ID. After that, the process proceeds to step B5.

On the other hand, when the processing target volume ID is registered in the connection information 205 (see a “no change” route), the process proceeds to step B5 without changing the connection information 205.

When the connection information 205 includes the volume ID that is not included in the volume information 106 (see a “deletion” route), the process proceeds to step B4. In step B4, the second controller 203 sets “Disconnect” in the request corresponding to the volume ID that is not included in the volume information 106 in the connection information 205. After that, the process proceeds to step B5.

In step B5, loop end processing corresponding to step B1 is implemented. When the processing with respect to all the entries (volume IDs) of the volume information 106 is completed, the present flow ends.

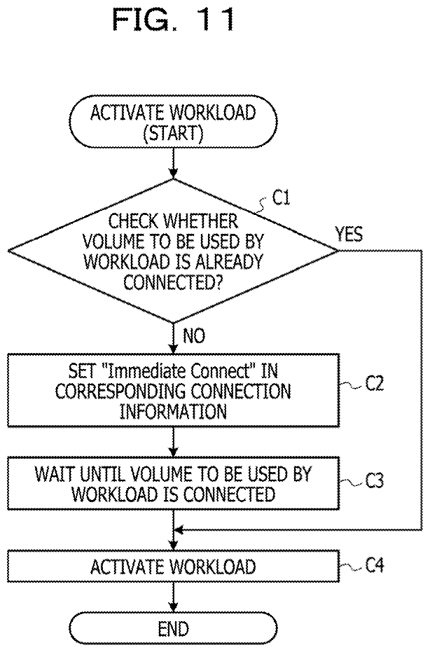

Next, processing at the time of the activation of the workload of the host device 20 in the storage system 1 as one example of the embodiment is described with reference to a flowchart (steps C1 to C4) illustrated in FIG. 11.

In step C1, the second controller 203 refers to the connection information 205, and checks whether or not the volume 30 (hereinafter, in some cases, referred to as the volume 30 scheduled to be used) to be used by the workload of the processing target is already connected.

As a result of the check, when the volume 30 scheduled to be used is not already connected (see a No route in step C1), the process proceeds to step C2.

In step C2, the second controller 203 sets “Immediate Connect” in the request corresponding to the volume ID of the volume 30 scheduled to be used in the connection information 205.

In step C3, the host device 20 waits until the volume 30 scheduled to be used is connected. The connection of the volume 30 scheduled to be used is performed by the second storage provisioner 202 in accordance with the instruction from the second controller 203, for example.

On the other hand, as a result of the check in step C1, when the volume 30 to be used by the workload is already connected (see a Yes route in step C1), the process proceeds to step C4.

Thereafter, in step C4, the second controller 203 causes the second workload orchestrator 201 to activate the workload, and the processing is ended.

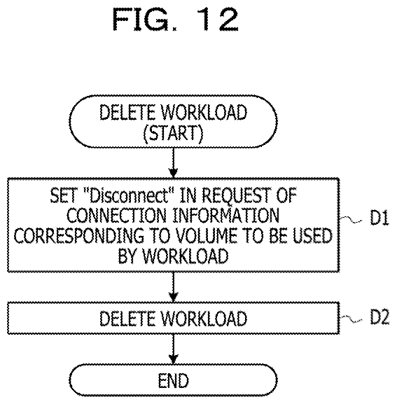

Next, workload deletion processing of the host device 20 in the storage system 1 as one example of the embodiment is described with reference to a flowchart (steps D1 and D2) illustrated in FIG. 12.

In step D1, the second controller 203 sets “Disconnect” in the request corresponding to the volume ID of the deletion target volume 30 used by the deletion target workload in the connection information 205.

In step D2, the second controller 203 instructs the second workload orchestrator 201 to delete the deletion target workload, and the second workload orchestrator 201 performs the deletion of the workload in accordance with this instruction. At this time, the second controller 203 may avoid waiting for the disconnection of the volume 30 used by the deletion target workload. Thereafter, the processing is ended.

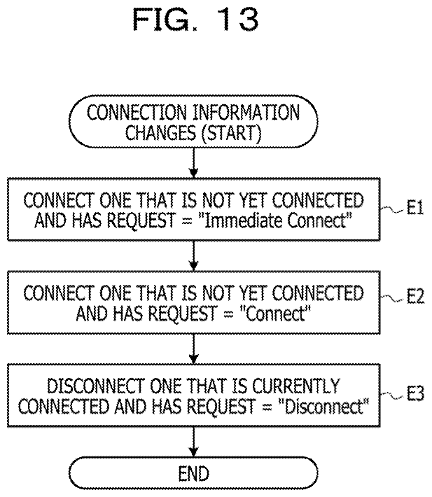

Next, connection and disconnection processing of the volume 30 of the host device 20 in the storage system 1 as one example of the embodiment is described with reference to a flowchart (steps E1 to E3) illustrated in FIG. 13.

The present processing is started when the connection information 205 is updated and a change has occurred in the contents in the host device 20.

In step E1, the second controller 203 issues, to the second storage provisioner 202, an instruction for connecting the volume 30 where “Immediate Connect” is set in the request in the connection information 205 to its own host device 20. The second storage provisioner 202 connects the specified volume 30 to its own host device 20 in accordance with this instruction.

In step E2, the second controller 203 issues, to the second storage provisioner 202, an instruction for connecting the volume 30 where “Connect” is set in the request in the connection information 205 to its own host device 20. The second storage provisioner 202 connects the specified volume 30 to its own host device 20 in accordance with this instruction.

In step E3, the second controller 203 issues, to the second storage provisioner 202, an instruction for disconnecting the volume 30 where “Disconnect” is set in the request in the connection information 205 from its own host device 20. The second storage provisioner 202 disconnects the specified volume 30 from its own host device 20 in accordance with this instruction. Thereafter, the processing is ended.

The above-described processing order for steps E1 to E3 is not limited to this, and may be appropriately changed and implemented. The processing order for steps E1 to E3 may be appropriately swapped, the processing may also be processed in parallel. The processing in step E1 is desirably executed by priority.

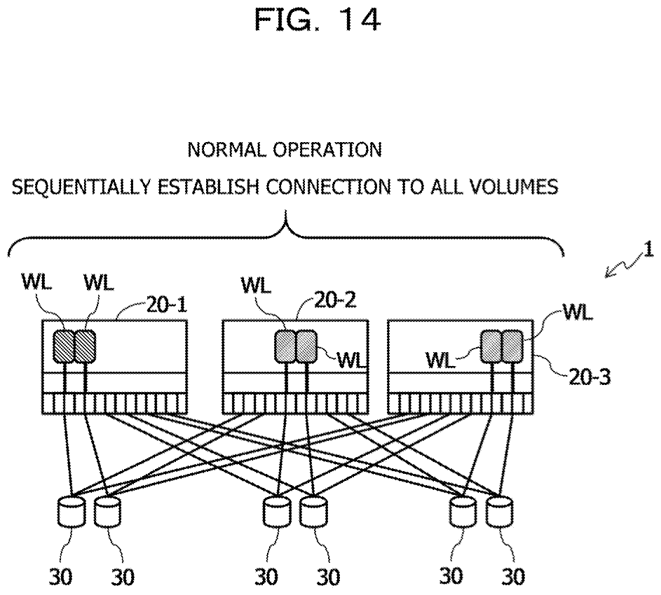

Next, processing when an anomaly occurs at the time of the operation in the storage system 1 as one example of the embodiment is described with reference to FIGS. 14 to 17.

At the time of the normal operation of the present storage system 1, for example, each of the host devices 20 sequentially establishes the connection to all the volumes 30 included in the present storage system 1 at the time of the activation of the present storage system 1 (see FIG. 14).

Thereafter, for example, when a failure occurs in the host device 20-1, the present storage system 1 proceeds to the maintenance mode. In the maintenance mode, the maintenance operation is performed with respect to the host device 20-1 where the failure has been detected.

The workload that has been allocated to the host device 20-1 is allocated to the other host device 20 by the first workload orchestrator 101. Instead of the host device 20 where the failure has occurred, the host device 20 to which the workload is allocated may be referred to as a substituted node. Hereinafter, in the drawing, the workload may be represented by assigning a reference sign WL.

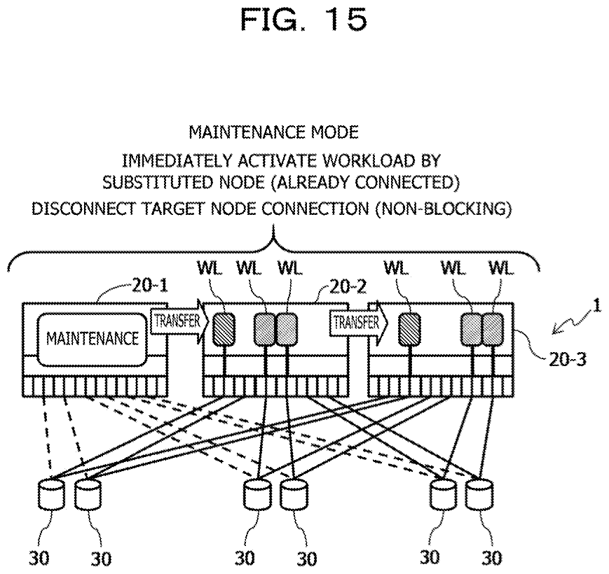

In the example illustrated in FIG. 15, the host device 20-2 and the host device 20-3 function as the substituted nodes.

As illustrated in FIG. 15, in the management device 10, the first workload orchestrator 101 allocates the container (workload) to the host devices 20-2 and 20-3 serving as the substituted nodes. Accordingly, the first controller 103 updates the workload information 104.

The first controller 103 creates the volume information 106 based on the created workload information 104 after the change, and transmits the corresponding volume information 106 to each of the host devices 20.

Each of the host devices 20 having received the volume information 106 connects/disconnects the volume 30 based on the received volume information 106.

In the present storage system 1, since all the volumes 30 included in the present storage system 1 are previously set in a state of being respectively connected to the host devices 20, the connection to the volume 30 may be performed at a high speed. Therefore, at the time of the transition to the maintenance mode, the container (workload) is immediately activated at the substituted node.

In the host device 20-1 of the maintenance target, the disconnection of the connection to each of the volumes 30 is performed in non-blocking processing where waiting (blocking) is not performed.

Thereafter, when the maintenance operation of the host device 20-1 is completed, the restoration from the maintenance mode to the normal operation mode is performed.

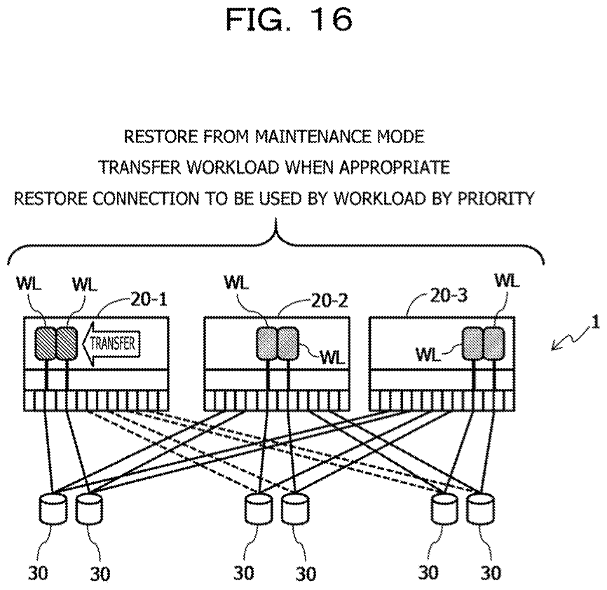

In this restoration from the maintenance mode, the transfer of the workload is performed when appropriate. In the example illustrated in FIG. 16, the first workload orchestrator 101 transfers the container (workload) from each of the host devices 20-2 and 20-3 serving as the substituted nodes to the host device 20-1.

In the management device 10, the first workload orchestrator 101 transfers (allocates) the container (workload) from each of the host devices 20-2 and 20-3 that have served as the substituted nodes to the recovered host device 20-1. Accordingly, the first controller 103 updates the workload information 104.

The first controller 103 creates the volume information 106 based on the created workload information 104 after the change, and transmits the corresponding volume information 106 to each of the host devices 20.

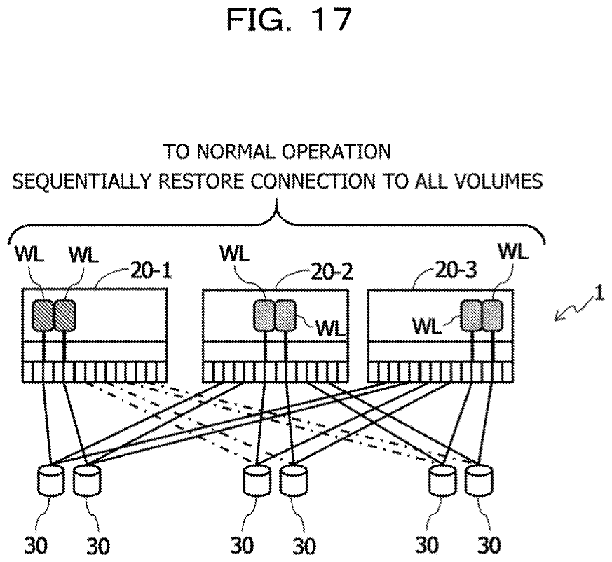

Each of the host devices 20 having received the volume information 106 connects/disconnects the volume 30 based on the received volume information 106. The connection of the volume 30 is performed by prioritizing one used by the workload. Each of the host devices 20 restores the volume 30 used by the workload by priority. Accordingly, the restoration to the normal operation mode is performed, and each of the host devices 20 sequentially recovers the connection to all the volumes 30 included in the present storage system 1 (see FIG. 17).

In the present storage system 1, since all the volumes 30 included in the present storage system 1 are previously set in a state of being respectively connected to the host devices 20, the connection to the volume 30 may be performed at a high speed. Therefore, at the time of the transition to the maintenance mode, the container (workload) is immediately activated at the substituted node.

In the host device 20-1, reconnection to the disconnected volume is performed.

(C) Advantages

In this manner, in accordance with the storage system 1 as one embodiment of the present invention, in the management device 10, the first controller 103 creates, for each of the host devices 20, the volume information 106 by extracting the volume 30 to which the host device 20 may be connected, and transmits the created volume information 106 to each of the corresponding host devices 20.

In each of the host devices 20, the second controller 203 connects the host device 20 corresponding to the host ID included in the received volume information 106 to its own host device 20.

Accordingly, when the transfer of the workload is performed between the host devices 20, since the connection (logical connection) of the volume 30 used by the workload is completed in the host device 20 at the transfer destination, the activation of the workload may be performed at a high speed. The connection switching of the volume 30 to the workload may be performed at a high speed. Accordingly, the features of the more lightweight container in which the high-speed activation is performed may be utilized.

The present storage system 1 is particularly effective in rolling update of software where a number of volume switching operations occur.

In the management device 10, the first controller 103 creates the workload information 104 based on the processing instruction of the workload performed by the first workload orchestrator 101. The workload information 104 is updated each time the execution instruction of the workload by the first workload orchestrator 101 is issued.

In the first controller 103, when the volume information 106 is created by using the thus progressively updated workload information 104, the number of the volumes 30 connected to the host device 20 that has received the volume information 106 is expected to be increased. In the host device 20 at the transfer destination of the workload, an expectation value at which the volume used by the workload is connected may be increased in accordance with an operating time of the present storage system 1.

In the present storage system 1, the switching of the volume 30 to each of the host devices 20 is controlled in the management device 10. Accordingly, the storage device 30 may avoid including a high performance CPU, and scalability may be obtained while costs of the storage device 30 (externally connected storage) are suppressed, and the performance is improved.

When the volume 30 that may be connected to each of the host devices 20 is previously connected, the transfer of the workload may be accelerated when the transfer of the workload is performed. Accordingly, it is sufficient when the workload to be transferred is sequentially deleted in the transfer source host device 20.

(D) Others

[Hardware Configuration of Management Device 10]

FIG. 18 is a diagram exemplifying a hardware configuration of the management device 10 in the storage system 1 as one example of an embodiment.

The management device 10 includes, for example, a processor 11, a random-access memory (RAM) 12, an HDD 13, a graphic processing device 14, an input interface 15, an optical drive device 16, a device connection interface 17, and a network interface 18 as components. These components 11 to 18 are configured so as to be mutually communicable via a bus 19.

The processor (processing unit) 11 controls the entirety of the management device 10. The processor 11 may be a multiprocessor. The processor 11 may be any one of a CPU, a microprocessor unit (MPU), a digital signal processor (DSP), an application-specific integrated circuit (ASIC), a programmable logic device (PLD), or a field-programmable gate array (FPGA), for example. The processor 11 may be a combination of two or more elements from among the CPU, the MPU, the DSP, the ASIC, the PLO, and the FPGA.

The RAM 12 is used as a main memory device of the host device 20. At least some of operating system (OS) programs and application programs, which are executed by the processor 11, are temporarily stored in the RAM 12. In the RAM 12, various kinds of data for use in processing by the processor 11 are stored. The application programs may include a workload management program for the management device and a volume connection control program for the management device which are executed by the processor 21 for realizing the volume connection switching function by the management device 10 according to the present embodiment.

The HDD 13 magnetically writes and reads data with respect to a built-in disk. The HDD 13 is used as an auxiliary storage device of the management device 10. The HDD 13 stores the OS programs, the application programs, and the various types of data. A semiconductor storage device such as an SCM or a flash memory may be used as the auxiliary storage device.

A monitor 14a is connected to a graphic processing device 14. The graphic processing device 14 displays an image in a screen of the monitor 14a in accordance with a command from the processor 11. A display device using a cathode ray tube (CRT), a liquid crystal display device, and the like are exemplified as the monitor 14a.

A keyboard 15a and a mouse 15b are connected to the input interface 15. The input interface 15 transmits signals sent from the keyboard 15a and the mouse 15b to the processor 11. The mouse 15b is an example of a pointing device, and other pointing devices may also be used. Examples of the other pointing device include a touch panel, a tablet, a touch pad, and a track ball.

The optical drive device 16 reads data recorded in an optical disk 26a using laser light or the like. The optical disk 16a is a portable non-transitory recording medium in which data is recorded which is readable using light reflection. Examples of the optical disk 16a include a digital versatile disc (DVD), a DVD-RAM, a compact disc read-only memory (CD-ROM), and a CD-recordable (R)/rewritable (RW).

The device connection interface 17 is a communication interface for connecting peripheral devices to the management device 10. The device connection interface 17 allows a memory device 17a and a memory reader/writer 17b to be connected, for example. The memory device 17a is a non-transitory recording medium, such as a Universal Serial Bus (USB) memory, to which a communication function with the device connection interface 17 is mounted. The memory reader/writer 17b writes data to a memory card 17c or reads data from the memory card 17c. The memory card 17c is a card-type non-transitory recording medium.

The network interface 18 is connected to the network 40. The network interface 18 transmits and receives data with the other computer or communication device via the network 40.

In the management device 10 including the aforementioned hardware configuration, when the processor 11 executes the workload management program for the management device, the above-described functions as the first workload orchestrator 101 and the first storage provisioner 102 are realized. When the processor 11 executes the volume connection control program for the management device, the above-described function as the first controller 103 is realized.

The RAM 12 stores the workload information 104 and the volume management information 105 (105-1, 105-2) described above. The workload information 104 and the volume management information 105 (105-1, 105-2) may be stored in the HDD 13.

[Hardware Configuration of Host Device 20]

FIG. 19 is a diagram exemplifying a hardware configuration of the host device 20 in the storage system 1 as one example of an embodiment.

The host device 20 includes a processor 21, a RAM 22, an HDD 23, a graphic processing device 24, an input interface 25, an optical drive device 26, a device connection interface 27, and a network interface 28 as components. These components 21 to 28 are configured so as to be mutually communicable via a bus 29.

Since the processor 21, the RAM 22, the HDD 23, the graphic processing device 24, the input interface 25, the optical drive device 26, the device connection interface 27, and the network interface 28 in the host device have similar functional configurations to those of the processor 11, the RAM 12, the HDD 13, the graphic processing device 14, the input interface 15, the optical drive device 16, the device connection interface 17, and the network interface 18 in the management device 10, the detailed descriptions are omitted.

The RAM 22 is used as a main memory device of the host device 20. At least some of OS programs and application programs, which are executed by the processor 21, are temporarily stored in the RAM 22. In the RAM 22, various kinds of data for use in processing by the processor 21 are stored. The application programs may include the workload management program (management program) for the host device and the volume connection control program (management program) for the host device which are executed by the processor 21 for realizing a defect part determination function according to the present embodiment by the host device 20. The workload management program for the host device and the volume connection control program for the host device may be set as one program (management program).

In the host device 20 having the above-described hardware configuration, when the processor 21 executes the workload management program for the host device, the functions as the second workload orchestrator 201 and the second storage provisioner 202 are realized. When the processor 21 executes the volume connection control program for the host device, the function as the second controller 203 described above is realized.

The connection status management information 204 and the connection information 205 described above are stored in the RAM 22. The connection status management information 204 and the connection information 205 may be stored in the HDD 23.

Techniques disclosed herein are not limited to the aforementioned embodiment and may include various modifications and changes without departing from the gist of the embodiment. The configurations and the processes according to the embodiment may be selectively used when appropriate, and alternatively, may be appropriately combined.

For example, according to the above-described embodiment, the three host devices 20-1 to 20-3 are included, but the configuration is not limited to this, and the implementation may be performed by appropriately changing the number of the host devices 20.

For example, according to the above-described embodiment, the four volumes 30-1 to 30-4 are included, but the configuration is not limited to this, and the implementation may be performed by appropriately changing the number of the volumes 30.

The present embodiment may be implemented or manufactured by those skilled in the art based on the above-described disclosure.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A management device in an information processing system, the information processing system including a plurality of information processing devices and a plurality of storage devices, the management device comprising:
a memory; and
a processor coupled to the memory, the processor being configured to
execute a notification information creation processing that includes
creating notification information, the notification information indicating, among the plurality of storage devices, one or more first storage devices that may be used by workload operating in a first information processing device among the plurality of information processing devices, and
execute a notification processing that includes
transmitting the notification information to the first information processing device, the notification information being configured to cause the first information processing device to perform logical connection to each of the one or more first storage devices indicated by the notification information.

2. The management device according to claim 1,
wherein the processor is further configured to
execute a workload management processing that includes
transmitting, to the first information processing device, an instruction for workload processing associated with the first storage device,
wherein the notification information creation processing is configured to
create the notification information by extracting the storage device that has been connected to the first information processing device, the extracting of the storage device being performed based on history information of the storage device and the first information processing device used in the workload processing which is obtained based on the instruction from the workload management processing.

3. An information processing system comprising:
a plurality of information processing devices; and
a plurality of storage devices,
the information processing system is configured to
execute a notification processing that includes
transmitting notification information to a first information processing device among the plurality of information processing devices, the notification information indicating, among the plurality of storage devices, one or more first storage devices that may be used by workload operating in the first information processing device, and
execute a connection control processing that includes
performing, in the first information processing device, logical connection to each of the one or more first storage devices indicated by the notification information.

4. The information processing system according to claim 3,
the information processing system is configured to
execute a workload management processing that includes
transmitting, to the first information processing device, an instruction for workload processing associated with the first storage device,
wherein the notification information creation processing is configured to
create the notification information by extracting the storage device that has been connected to the first information processing device, the extracting of the storage device being performed based on history information of the storage device and the first information processing device used in the workload processing which is obtained based on the instruction from the workload management processing.

5. A non-transitory computer-readable storage medium for storing a management program which causes a processor of a management device in an information processing system including a plurality of information processing devices and a plurality of storage devices, to perform processing comprising:
creating notification information, the notification information indicating, among the plurality of storage devices, one or more first storage devices that may be used by workload operating in a first information processing device among the plurality of information processing devices; and
transmitting the notification information to the first information processing device, the notification information being configured to cause the first information processing device to perform logical connection to each of the one or more first storage devices indicated by the notification information.

6. The non-transitory computer-readable storage medium according to claim 5,
the processing further comprising:
executing a workload management processing that includes
transmitting, to the first information processing device, an instruction for workload processing associated with the first storage device,
wherein the notification information creation processing is configured to
create the notification information by extracting the storage device that has been connected to the first information processing device, the extracting of the storage device being performed based on history information of the storage device and the first information processing device used in the workload processing which is obtained based on the instruction from the workload management processing.
